(19) United States
(12) Patent Application Publication
(10) Pub. No.: US 2010/0057747 A1
(43) Pub. Date: Mar. 4, 2010

(54) UNIVERSAL PIXEL MANAGEMENT

(75) Inventor: Johannes Cornelius Schouten, New York, NY (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/203,312

(22) Filed: Sep. 3, 2008

(51) Int. Cl. G06F 17/30

(52) U.S. Cl. 707/10; 707/E17.001

(57) ABSTRACT

A single universal reporting pixel is embedded in a web page. The web page may contain one or more advertisements. One or more third-party reporting pixels are associated with the universal reporting pixel. Upon serving the web page, the universal reporting pixel causes each of the active and qualifying third-party reporting pixels associated with the universal reporting pixel to send a report to the third party associated with the third-party reporting pixel. The third-party reporting pixels associated with the universal reporting pixel may be changed at any time. A user interface may be provided to associate and disassociate third-party reporting pixels to a universal reporting pixel.

### TECHNICAL FILED

The present disclosure generally relates to collecting statistical information concerning advertisements placed on the Internet. More specifically, the present disclosure enables multiple entities to collect statistical information concerning advertisements placed in web pages.

### BACKGROUND

Advertising on the Internet has grown into a multi-billion-dollar business. In a common scenario, an advertising service provider provides the Internet advertising medium. The advertising medium may take various forms, such as web pages, live feeds, electronic messages, etc. An advertiser, also referred to as a sponsor, may purchase a certain amount of advertising space from the advertising service provider to place its advertisements in the advertising medium provided by the advertising service provider. For example, it is common to find ad banners and/or other forms of advertisements (e.g., clickable images, icons, texts, etc.) included in web pages along with the primary content of the web pages.

FIG. 1 (prior art) illustrates a portion of a sample web page 100 that contains an advertisement 110. The advertisement 110 is located near the web page's 100 lower right corner. In this example, the advertising service provider is Yahoo, Inc.; the advertising medium is the web page 100; and the sponsor is Netflix, Inc. Netflix, Inc. has purchased a certain amount of space in the web page 100 from Yahoo, Inc. to place the advertisement 110 in the web page 100. A user viewing the web page 100 may click on the advertisement 110 and be redirected to Netflix Inc.'s website.

For various business reasons, it is often desirable and sometimes necessary to collect statistical information concerning the advertisements placed in the Internet advertising medium. For example, both the advertising service provider and the sponsor may wish to know how many times a particular advertisement has been viewed by users, how many times a particular advertisement has been clicked by users, how much revenue a particular advertisement has generated, etc. Although various methods have been developed to collect these types of information concerning the advertisements, not all of these methods are convenient in practice (i.e., user friendly).

### SUMMARY

Broadly speaking, the present disclosure generally relates to collecting statistical information concerning advertisements placed on the Internet.

According to various embodiments, a single universal reporting pixel is embedded in a web page. The web page includes one or more advertisements that are associated with various third parties. The universal reporting pixel is associated with one or more third-party reporting pixels having different syntax and/or format requirements.

Upon serving the web page, the universal reporting pixel embedded therein causes each of the qualifying third-party reporting pixels associated with the universal reporting pixel to send a report to its respective destination.

The third-party reporting pixels associated with the universal reporting pixel may be modified as needed. Optionally, interfaces are provided for associating third-party reporting pixels to the universal reporting pixel.

These and other features, aspects, and advantages of the disclosure will be described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 (prior art) illustrates a portion of a sample web page that contains an advertisement.

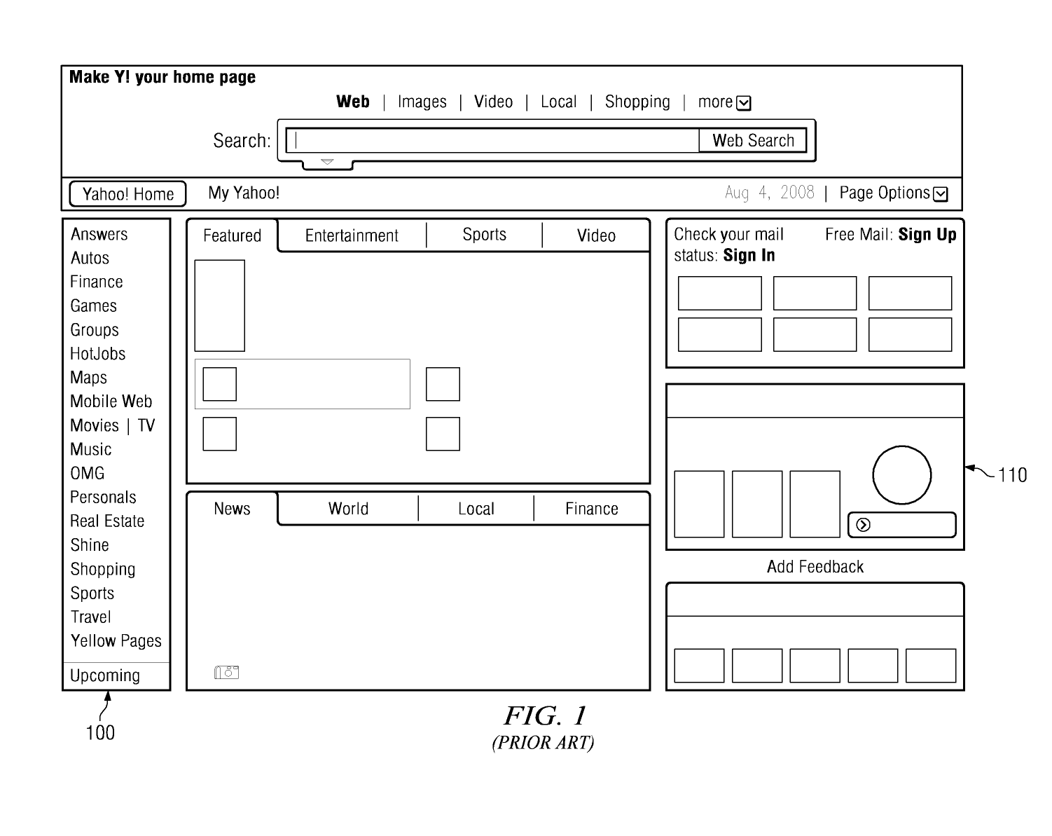

FIG. 2 (prior art) illustrates a sample web page having four reporting pixels embedded therein.

FIG. 3 illustrates a web page having a universal reporting pixel associated with four third-party reporting pixels according to one embodiment of the present disclosure.

FIG. 4 illustrates a method of utilizing a universal reporting pixel in a web page to report to multiple third-parties according to one embodiment of the present disclosure.

FIG. 5 illustrates a sample user interface that enables a user to associate third-party reporting pixels to a universal pixel according to one embodiment of the present disclosure.

FIG. 6 illustrates a general computer system suitable for implementing embodiments of the present disclosure.

### DETAILED DESCRIPTION

The present disclosure will now be described in detail with reference to a few preferred embodiments thereof as illustrated in the accompanying drawings. In the following description, numerous specific details are set forth in order to provide a thorough understanding of the present disclosure. It will be apparent, however, to one skilled in the art, that the present disclosure may be practiced without some or all of these specific details. In other instances, well known process steps and/or structures have not been described in detail in order to not unnecessarily obscure the present disclosure. In addition, while the disclosure will be described in conjunction with the particular embodiments, it will be understood that this description is not intended to limit the disclosure to the described embodiments. To the contrary, the description is intended to cover alternatives, modifications, and equivalents as may be included within the spirit and scope of the disclosure as defined by the appended claims.

For Internet advertising, it is often desirable and sometimes necessary to collect statistical information concerning the advertisements placed in the Internet advertising medium, such as web pages. For example, one way to determine the number of times a particular advertisement has been viewed by users during a certain period of time is to embed one or more reporting pixels in the web page that contains the advertisement.

In the context of Internet advertising, a reporting pixel is usually a one-by-one pixel that may be placed anywhere, but preferably at an inconspicuous or unobtrusive location, in a web page. Each time the web page is served in response to a client request, the reporting pixel initiates a callback to a server associated with the reporting pixel, indicating that the web page has been viewed and optionally reporting additional information such as the identification of the reporting pixel, the date and time the web page is served, and/or the publisher of the web page, etc. The server may be associated with an advertising service provider, an advertiser, a publisher, a network, etc. The server collects and aggregates information from multiple callbacks for a period of time to determine the total number of times the web page, and consequently the advertisement that directed the user to the web page, has been viewed during that period.

Often, servers associated with different parties have different protocol (e.g., syntax and/or format) requirements for their respective reporting pixels. The following are three sample reporting pixels, each a one-by-one pixel and having a different syntax:

<img src=“http://ad.yieldmanager.com/pixel?id=80437&t=2”
width=“1” height=“1” />
<script src=“http://ad.yieldmanager.com/pixel?id=96913&t=1”
type=“text/javascript”></script>
<img src=“//ac4-intrm-
008.ysm.ac4.yahoo.com:9999/pixel?id=4191001&t=2” width=“1”
height=“1” />

Note that each pixel has a unique identification, which is specified using the “id” argument. This unique identification (i.e., pixel ID) may be used to identify each specific reporting pixel.

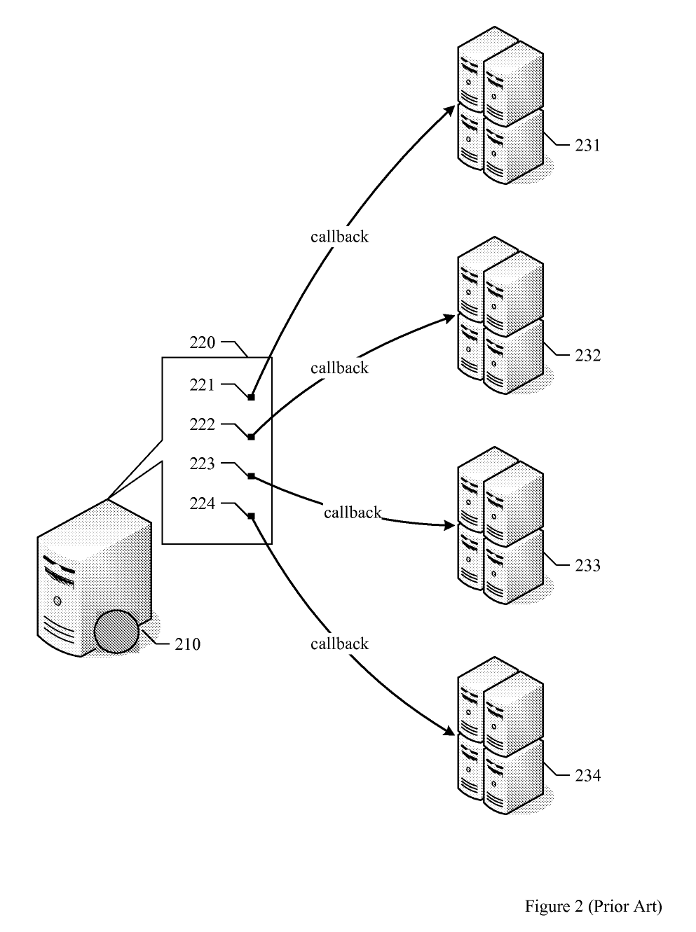

Consequently, to report to multiple servers associated with different parties, multiple reporting pixels, each satisfying the specific requirements of a particular party's server, may need to be embedded in a web page that contains advertisements. FIG. 2 (prior art) illustrates a sample web page 220 having four reporting pixels 221, 222, 223, 224 embedded therein. The four reporting pixels 221, 222, 223, 224 are exaggerated in size to visually illustrate the concept. The four reporting pixels 221, 222, 223, 224 are associated with four different destination servers 231, 232, 233, 234 respectively, and each of the four servers 231, 232, 233, 234 has different protocol requirements for its reporting pixels. The web page 220 contains one or more advertisements.

Suppose the web page 220 is served by the web server 210. Each time the web page 220 is served in response to a client request, the four embedded reporting pixels 221, 222, 223, 224 each initiates a callback to its own associated server. Thus, reporting pixel 221 initiates a callback to server 231; reporting pixel 222 initiates a callback to server 232; reporting pixel 223 initiates a callback to server 233; and reporting pixel 224 initiates a callback to server 234.

Embedding multiple reporting pixels in a web page in order to report to multiple servers associated with different parties is cumbersome. Each time a party's server is added or deleted from the reporting list or each time a party's server changes the protocol requirements for its reporting pixels, the source code of the web page needs to be modified (e.g., to add or delete a reporting pixel or to modify the code of a reporting pixel).

To remedy this problem, a single universal reporting pixel is embedded in a web page that contains advertisements. The universal reporting pixel is associated with one or more third-party reporting pixels. Each time the web page is served, the universal reporting pixel initiates a callback to its own associated server. This server then causes each of the qualifying third-party reporting pixels associated with the universal reporting pixel to initiate a callback to the destination server with which the third-party reporting pixel is associated.

An interface may be provided for associating third-party reporting pixels to the universal reporting pixel. As a result, once the universal reporting pixel is embedded in a web page (i.e., put in place), the source code of the web page remains unchanged. Each time a third-party's server is added or deleted from the reporting list or each time a third-party's server changes the protocol requirements for its reporting pixels, only the associations with the universal reporting pixel is modified.

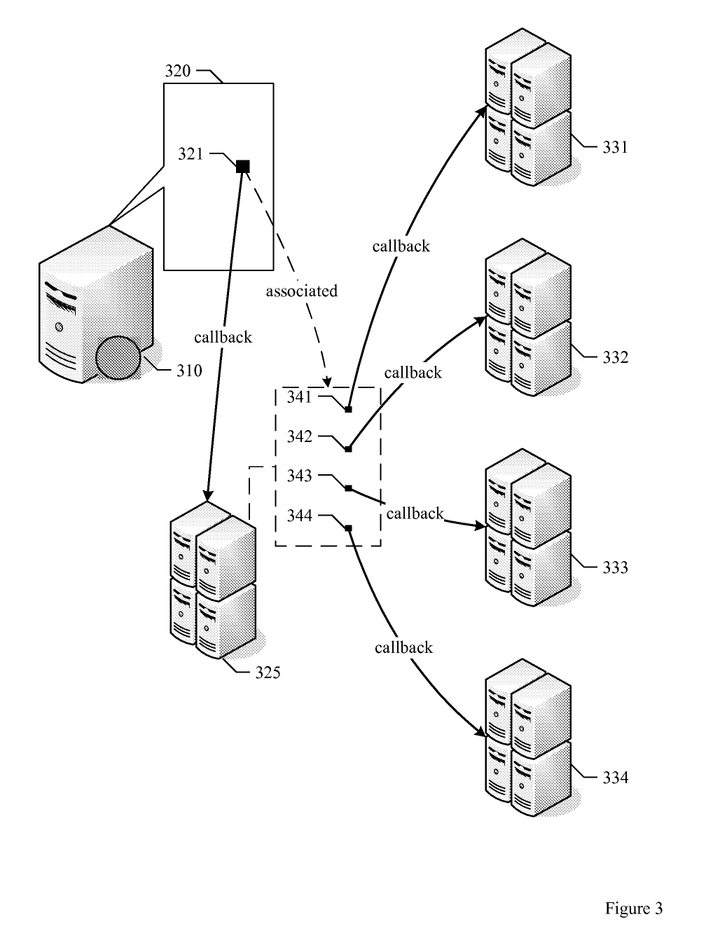

FIG. 3 illustrates a web page 320 having a universal reporting pixel 321 associated with four third-party reporting pixels 341, 342, 343, 344 according to one embodiment of the present disclosure. The universal reporting pixel 321 and the four third-party reporting pixels 341, 342, 343, 344 are exaggerated in size to visually illustrate the concept. Similar to FIG. 2, the four third-party reporting pixels 341, 342, 343, 344 are associated with four different third-party destination servers 331, 332, 333, 334 respectively, and each of the four third-party servers 331, 332, 333, 334 has different protocol requirements for its reporting pixels.

On the other hand, unlike FIG. 2, the four third-party reporting pixels 341, 342, 343, 344 are not embedded in the web page 320. Instead, the single universal reporting pixel 321 is embedded in the web page 320, replacing all other reporting pixels. The universal reporting pixel 321 is associated with the four third-party reporting pixels 341, 342, 343, 344. To identify a universal reporting pixel or a third-party reporting pixel, according to one embodiment, each universal or third-party reporting pixel is assigned a unique identification.

Suppose the web page 320 is served by the web server 310. Each time the web page 320 is served in response to a client request, the embedded universal reporting pixel 321 initiates a callback to server 325, which is associated with the universal reporting pixel 321. Server 325 then causes each of the third-party reporting pixel 341, 342, 343, 344 associated with the universal reporting pixel 321 to initiate a callback to its own associated server. Thus, third-party reporting pixel 341 initiates a callback to server 331; third-party reporting pixel 342 initiates a callback to server 332; third-party reporting pixel 343 initiates a callback to server 333; and third-party reporting pixel 344 initiates a callback to server 334.

In an alternative embodiment, web server 310 and server 325 may be combined into a single server. That is, one single server may perform the functionalities of both serving the web pages and managing third-party reporting pixels associated with the universal reporting pixels,

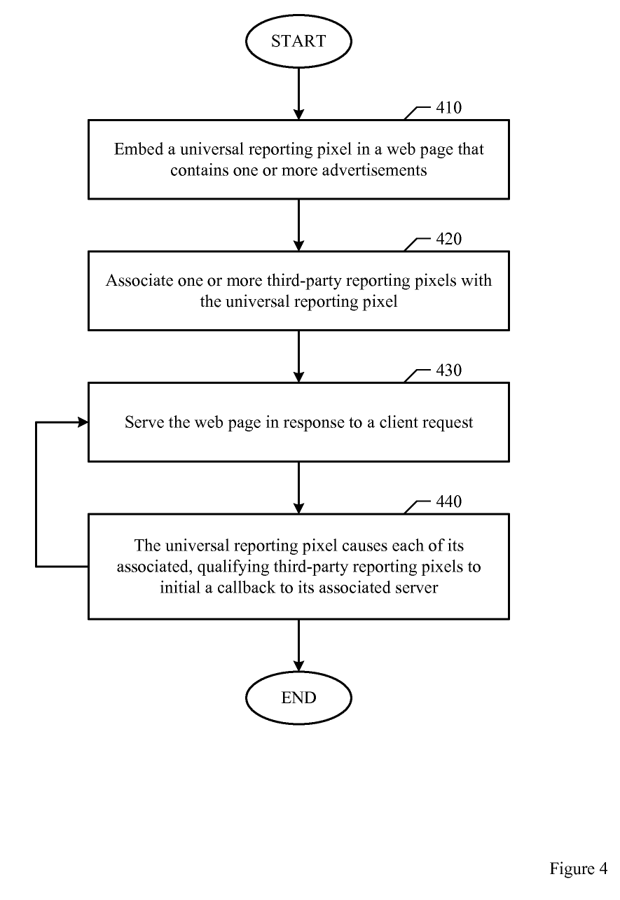

FIG. 4 illustrates a method of utilizing a universal reporting pixel in a web page to report to multiple third-parties according to one embodiment of the present disclosure. A universal reporting pixel is embedded in a web page that contains one or more advertisements (step 410). The universal reporting pixel is associated with its own server (e.g., server 325 in FIG. 3). The source code of the web page may be modified to include the code for the universal reporting pixel. The following is a sample universal reporting pixel:

<img src=“http://ad.testupixel.com/pixel?id=12345&t=2”
width=“1” height=“1” />

Note that the pixel has a unique identification, which is specified using the “id” argument. This unique identification (i.e., pixel ID) may be used to identify the specific universal reporting pixel.

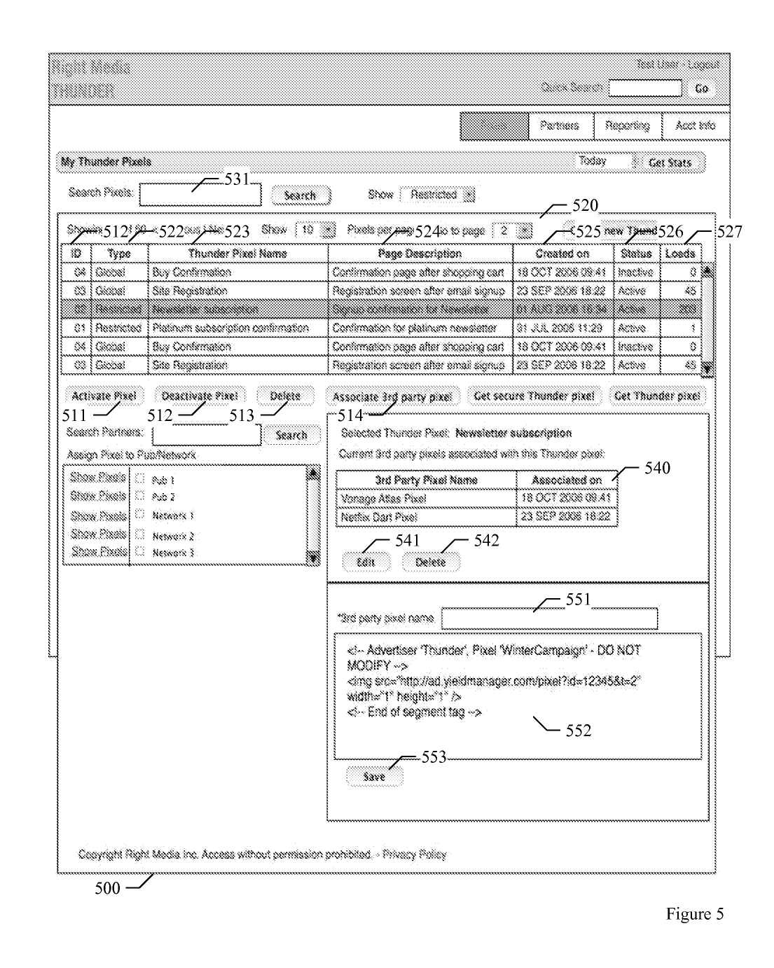

One or more third-party reporting pixels are associated with the universal reporting pixel (step 420). Each third-party reporting pixel is associated with a server associated with a third-party (e.g., servers 331, 332, 333, 334 in FIG. 3). According to one embodiment, a user interface may be provided to enable a user to associate third-party reporting pixels with any universal reporting pixel. A sample user interface is described below in FIG. 5. The information (i.e., the universal reporting pixel and its associated third-party reporting pixels) may be stored in a memory location accessible by the server associated with the universal reporting pixel (e.g., server 325 in FIG. 3). Various data structures, such as a lookup table, may be used to represent the relationships between a universal reporting pixel and its associated third-party reporting pixels. For example, if each universal or third-party reporting pixel is assigned a unique identification, then this unique identification may be used to identify the universal or third-party reporting pixels when necessary.

Each time the web page is served in response to a client request by the web server hosting the web page (step 430), the universal reporting pixel embedded in the web page initiates a callback to its own associated server, which then causes each of the third-party reporting pixels associated with the universal reporting pixel to initiate a callback to the server associated with the particular third-party reporting pixel (step 440). The memory location where the relationships between the universal reporting pixels and their respectively associated third-party reporting pixels are stored is accessed by, for example, the server associated with the universal reporting pixel that receives the callbacks from the universal reporting pixel to determine the specific third-party reporting pixels associated with the universal reporting pixel embedded in the web page. The third-party reporting pixels associated with the universal reporting pixel embedded in the web page are then executed to initiate the appropriate callbacks.

Steps 430 and 440 are repeated each time a client request is received for the web page. Furthermore, the third-party reporting pixels associated with any universal reporting pixel may be modified at any time. For example, a new third-party reporting pixel may be associated with a universal reporting pixel or an existing third-party reporting pixel that is currently associated with a universal reporting pixel may be disassociated with the universal reporting pixel. Similarly, the third-party reporting pixel may be modified, such as sending the reporting to a different server or including different information in the report. Furthermore, a third-party reporting pixel that is currently associated with a universal reporting pixel may be temporarily deactivated and later reactivated. During the period of deactivation, no report is sent to the third-party associated with deactivated third-party reporting pixel.

According to one embodiment, the modification may be done through a user interface. FIG. 5 illustrates a sample user interface 500 that enables a user to associated third-party reporting pixels to a universal pixel according to one embodiment of the present disclosure. The actual designs, layouts, functionalities, etc. of such a user interface often vary according to the specific requirements of each implementation.

In the example shown in FIG. 5, different interface components are employed for different purposes. For example, several buttons are provided to enable a user to activate a pixel 511, deactivate a pixel 512, delete a pixel 513, associated a third-party pixel 514, etc. The pixels currently existing in the system are displayed in a list 520, which provides various information for each pixel, including the pixel's identification 521, type, 522, name 523, description 524, creating date 525, current status 526, and loads 527. A search field 531 enables a user to search for a specific pixel.

The third-party pixels currently associated with the universal pixel displayed in the interface are displayed in a list 540. A user may edit or delete each of these third-party pixels in the list 540 by pressing the edit button 541 or the delete button 542. A new third-party pixel may be added by specifying its name 551, code 552, and then pressing the save button 553.

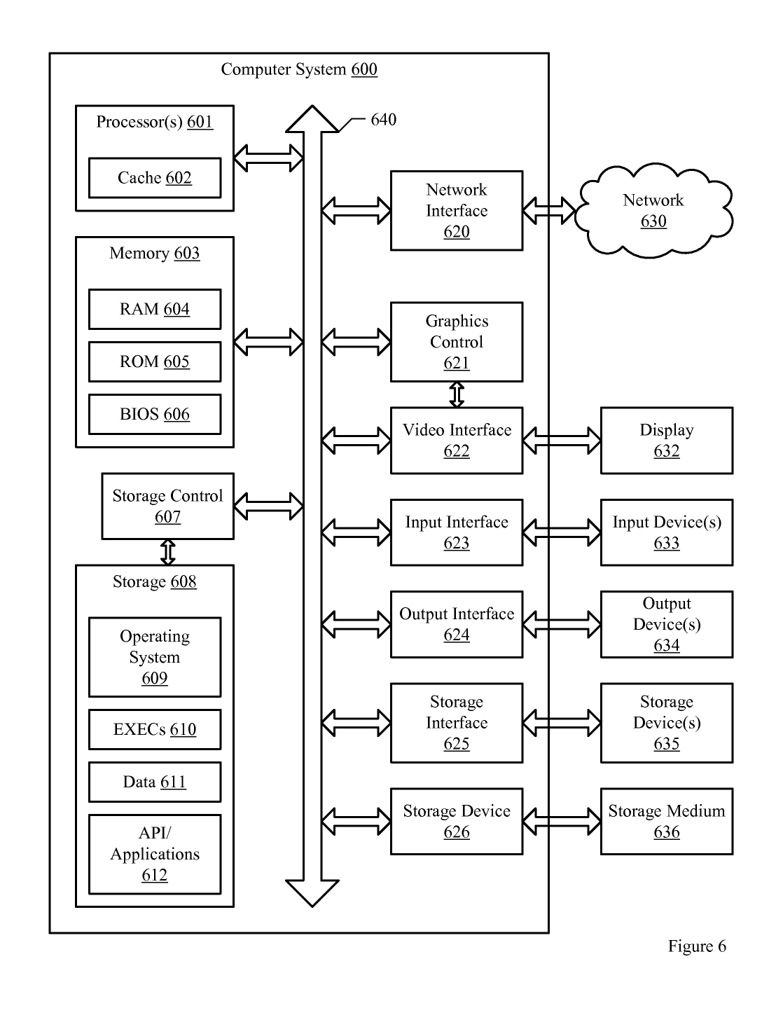

The method illustrated in FIG. 4 may be implemented as computer software using computer-readable instructions and stored in computer-readable medium. The software instructions may be executed on various types of computers. For example, FIG. 6 illustrates a computer system 600 suitable for implementing embodiments of the present disclosure. The components shown in FIG. 6 for computer system 600 are exemplary in nature and are not intended to suggest any limitation as to the scope of use or functionality of the API. Neither should the configuration of components be interpreted as having any dependency or requirement relating to any one or combination of components illustrated in the exemplary embodiment of a computer system. The computer system 600 may have many physical forms including an integrated circuit, a printed circuit board, a small handheld device (such as a mobile telephone or PDA), a personal computer or a super computer.

Computer system 600 includes a display 632, one or more input devices 633 (e.g., keypad, keyboard, mouse, stylus, etc.), one or more output devices 634 (e.g., speaker), one or more storage devices 635, various types of storage medium 636.

The system bus 640 link a wide variety of subsystems. As understood by those skilled in the art, a “bus” refers to a plurality of digital signal lines serving a common function. The system bus 640 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 601 (also referred to as central processing units, or CPUs) optionally contain a cache memory unit 602 for temporary local storage of instructions, data, or computer addresses. Processor(s) 601 are coupled to storage devices including memory 603. Memory 603 includes random access memory (RAM) 604 and read-only memory (ROM) 605. As is well known in the art, ROM 605 acts to transfer data and instructions uni-directionally to the processor(s) 601, and RAM 604 is used typically to transfer data and instructions in a bi-directional manner. Both of these types of memories may include any suitable of the computer-readable media described below. A fixed storage 608 is also coupled bi-directionally to the processor(s) 601, optionally via a storage control unit 607. It provides additional data storage capacity and may also include any of the computer-readable media described below. Storage 608 may be used to store operating system 609, EXECs 610, application programs 612, data 611 and the like and is typically a secondary storage medium (such as a hard disk) that is slower than primary storage. It will be appreciated that the information retained within storage 608, may, in appropriate cases, be incorporated in standard fashion as virtual memory in memory 603.

Processor(s) 601 is also coupled to a variety of interfaces such as graphics control 621, video interface 622, input interface 623, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 601 may be coupled to another computer or telecommunications network 630 using network interface 620. With such a network interface 620, it is contemplated that the CPU 601 might receive information from the network 630, or might output information to the network in the course of performing the above-described method steps. Furthermore, method embodiments of the present disclosure may execute solely upon CPU 601 or may execute over a network 630 such as the Internet in conjunction with a remote CPU 601 that shares a portion of the processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
embedding a universal reporting pixel in a web page;
associating at least one third-party reporting pixel with the universal reporting pixel;
serving the web page; and
causing each of the at least one qualifying third-party reporting pixel to send a report to a third party associated with the third-party reporting pixel,
wherein the universal reporting pixel causes each of the at least one third-party reporting pixel to send the report when the web page is served.

2. A method as recited in claim 1, wherein causing each of the at least one qualifying third-party reporting pixel to send a report to a third party associated with the third-party reporting pixel comprises:
initiating a callback to a server associated with the universal reporting pixel;
determining the at least one qualifying third-party reporting pixel associated with the universal reporting pixel; and
executing each of the at least one qualifying third-party reporting pixel.

3. A method as recited in claim 2, wherein initiating a callback to a server associated with the universal reporting pixel comprises:
executing the universal reporting pixel.

4. A method as recited in claim 1, further comprising:
modifying selected ones of the at least one third-party reporting pixel associated with the universal reporting pixel.

5. A method as recited in claim 1, further comprising:
disassociating selected ones of the at least one third-party reporting pixel associated with the universal reporting pixel.

6. A method as recited in claim 1, further comprising:
deactivating selected active ones of the at least one third-party reporting pixel associated with the universal reporting pixel.

7. A method as recited in claim 1, further comprising:
activating selected de-active ones of the at least one third-party reporting pixel associated with the universal reporting pixel.

8. A method as recited in claim 1, wherein the report sent by one of the at least one third-party pixel to a third party associated with the third-party reporting pixel is sent to a server associated with the third party and includes information concerning the third-party reporting pixel.

9. A method as recited in claim 8, wherein the information concerning the third-party reporting pixel sent to a third-party is specified by the third-party reporting pixel associated with the third-party.

10. A user interface, comprising a plurality of interface components, wherein selected ones of the plurality of interface components enable a user to:
define a universal reporting pixel;
define a third-party reporting pixel; and
associate the third-party reporting pixel with the universal reporting pixel,
wherein when a web page in which the universal reporting pixel is embedded is served, the universal reporting pixel causes the third-party reporting pixel associated with the universal reporting pixel to send a report to a third party associated with the third-party reporting pixel.

11. A method as recited in claim 10, wherein selected ones of the plurality of interface components further enable the user to:
disassociate the third-party reporting pixel with the universal reporting pixel.

12. A method as recited in claim 10, wherein selected ones of the plurality of interface components further enable the user to:
modify the third-party reporting pixel with the universal reporting pixel.

13. A method as recited in claim 10, wherein selected ones of the plurality of interface components further enable the user to:
deactivating the third-party reporting pixel with the universal reporting pixel.

14. A method as recited in claim 10, wherein selected ones of the plurality of interface components further enable the user to:
activating the third-party reporting pixel with the universal reporting pixel.

15. A computer program product comprising a computer-readable medium having a plurality of computer program instructions stored therein, which are operable to cause at least one computing device to:
embed a universal reporting pixel in a web page;
associate at least one third-party reporting pixel with the universal reporting pixel;
serve the web page; and
cause each of the at least one third-party reporting pixel to send a report to a third party associated with the third-party reporting pixel,
wherein the universal reporting pixel causes each of the at least one third-party reporting pixel to send the report when the web page is served.

16. A computer program product as recited in claim 15, wherein to cause each of the at least one qualifying third-party reporting pixel to send a report to a third party associated with the third-party reporting pixel comprises:
execute the universal reporting pixel to initiate a callback to a server associated with the universal reporting pixel;
determine the at least one third-party reporting pixel associated with the universal reporting pixel; and
execute each of the at least one qualifying third-party reporting pixel.

17. A computer program product as recited in claim 15, wherein the plurality of computer program instructions are further operable to cause at least one computing device to:
modify selected ones of the at least one third-party reporting pixel associated with the universal reporting pixel.

18. A computer program product as recited in claim 15, wherein the plurality of computer program instructions are further operable to cause at least one computing device to:
disassociate selected ones of the at least one third-party reporting pixel associated with the universal reporting pixel.

19. A computer program product as recited in claim 15, wherein the plurality of computer program instructions are further operable to cause at least one computing device to:
deactivate selected active ones of the at least one third-party reporting pixel associated with the universal reporting pixel.

20. A computer program product as recited in claim 15, wherein the plurality of computer program instructions are further operable to cause at least one computing device to:
activate selected de-active ones of the at least one third-party reporting pixel associated with the universal reporting pixel.
